(19) United States
(12) Patent Application Publication
(10) Pub. No.: US 2008/0147319 A1
(43) Pub. Date: Jun. 19, 2008

(54) LANDMARK SELECTION TOOLS FOR MAP SYSTEMS AND METHODS

(75) Inventor: Pedro A. Cubillo, Medford, MA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Laboratories Inc., Waltham, MA (US)

(21) Appl. No.: 11/612,695

(22) Filed: Dec. 19, 2006

(51) Int. Cl. G01C 21/30

(52) U.S. Cl. 701/211

(57) ABSTRACT

An exemplary system includes a system includes a map subsystem configured to provide data representative of a map to an access device communicatively coupled to the map subsystem, the map being representative of a geographic area. The map subsystem is further configured to provide a landmark selection tool to the access device, the landmark selection tool including at least one selectable landmark option associated with at least one landmark located within the geographic area. The map subsystem is further configured to detect a user selection of the at least one selectable landmark option and provide, in response to the user selection, at least one visual indicator of the at least one landmark for display on the map. In certain embodiments, the at least one selectable landmark option includes a plurality of selectable landmark options prioritized in relation to one another for display in a graphical user interface.

### BACKGROUND INFORMATION

Computerized applications have been developed for generating and providing data representative of maps in response to user requests. For example, a user may access a conventional map application, identify an address, and receive in return a map of a geographic area including the address location. Such maps are commonly used in driving direction applications and usually illustrate streets, street names, and driving routes between locations.

Unfortunately, traditional computer-generated street maps include limited information and/or are not user friendly. For example, conventional map applications provide users with little or no capabilities for customizing the maps to fit specific preferences and/or situations of the users. In particular, a user of a conventional application is unable to customize the contents of the maps. Moreover, operators of traditional map applications may be losing out on revenue that could be generated by improved, user-friendly, and customizable maps.

These and other shortcomings of conventional map applications tend to frustrate users who desire a greater level of control over the contents of street maps. For at least these reasons, there is a need for systems and methods that provide users with more user-friendly map tools, including tools enabling users to customize the contents of the maps.

### BRIEF DESCRIPTION OF THE DRAWINGS

The accompanying drawings illustrate various exemplary implementations and are a part of the specification. The illustrated implementations are merely examples and do not limit the scope of the disclosure. Throughout the drawings, identical reference numbers designate identical or similar elements.

FIG. 1 is a block diagram illustrating an exemplary map system.

FIG. 2 illustrates an exemplary graphical user interface including an exemplary map and landmark options link.

FIG. 3 illustrates another exemplary graphical user interface including an exemplary landmark selection tool.

FIG. 4 illustrates another exemplary graphical user interface including another exemplary landmark selection tool.

FIG. 5 illustrates another exemplary graphical user interface including yet another exemplary landmark selection tool.

FIG. 6 illustrates the exemplary graphical user interface of FIG. 2 with visual indicators of user selected landmarks displayed on the map.

FIG. 7 illustrates another exemplary graphical user interface including an exemplary map and landmark selection tool.

FIG. 8 is a block diagram illustrating another exemplary map system.

FIG. 9 is a flowchart illustrating an exemplary process for providing a landmark selection tool for selection of landmarks for display on a map.

### DETAILED DESCRIPTION OF PREFERRED EMBODIMENTS

### I. Introduction

Exemplary implementations of systems and methods provide landmark selection tools enabling selections of landmarks for display on maps. The systems and methods may provide an access device with data representative of a map (e.g., a digital map) of a geographic area. The map may be provided in response to a user request. The systems and methods may also provide the user with a landmark selection tool configured to enable the user to select at least one landmark to be displayed on the map. An exemplary landmark selection tool may include one or more selectable landmark options from which the user can choose at least one landmark to be displayed on the map. When the user selects a landmark option, the systems and methods may provide at least one visual indicator of the landmark(s) associated with the landmark option for display on the map. In this manner, the user can customize the contents of the map, including selecting landmarks of interest for inclusion on the map.

As used herein, the term “landmark” refers to any location, object, place, or service located or provided within a geographic area represented by a digital map. Examples of landmarks include, but are not limited to, buildings (e.g. office buildings), businesses, parks, structures, hotels, eateries, coffee shops, restaurants, bars, clubs, post offices, delivery services pick-up and/or drop-off locations, laundry service locations, fuel stations, convenience stores, grocery stores, shopping malls, retail stores, business chain stores, vehicle dealerships, repair shops, recreation centers, car rental locations, airports, parking lots, financial institutions (e.g., banks), automated teller machines (“ATMs”), police stations, fire stations, docks, boat ramps, zoos, theme parks, theaters, museums, historical sites, libraries, stadiums, hospitals, urgent care facilities, health service provider facilities, golf courses, sports facilities, gyms, schools, warehouses, storage sites, government sites, recreational areas, retirement communities, religious sites or structures, nursing homes, apartment complexes, real property for sale or rent, residential communities, visitor centers, well-known structures or sites, etc. In certain exemplary approaches, landmarks include one or more locations having street addresses, which can be used to associate appropriate landmarks with positions on maps, as described below.

The term “landmark data” refers to any representation of information descriptive of one or more landmarks. Landmark data may include landmark identifiers (e.g., landmark names such as names of retail businesses) and/or landmark attributes, including, but not limited to, location identifier (e.g., street address), color, shape, size, logo, etc. Exemplary landmark data will be described in more detail further below.

The exemplary landmark selection tools described herein provide users with capabilities for flexibly controlling what information will be shown as part of computer-generated maps. The tools can be especially helpful to users wishing to make travel plans or who wish to locate specific landmarks in an unfamiliar area. For example, a person planning to drive to an airport for a flight may request a map of a geographic area that includes or is proximate to the airport. In addition, the user can select landmarks such as airport parking lots/services and ATMs operated by a specific bank to be displayed on the map. The result may be a map that has been customized by the user to fit his or her specific preferences and/or situation. Exemplary landmark selection tools will be described further below.

Exemplary systems and methods can be used to generate revenue. For example, sponsors may be charged a fee for inclusion and/or prioritization of their landmark data in landmark selection tools and/or maps. Businesses or other sponsors may bid for inclusion and/or prioritization of their landmark data in the landmark selection tools and/or maps. Sponsors can be charged using any suitable billing arrangement, including “pay-per-inclusion” and “pay-per-display” arrangements, examples of which are described further below. In certain envisioned approaches, selectable landmark options included in landmark selection tools are generated based on landmark data that has been produced based on listings in a directory subsystem.

### II. Exemplary System Views

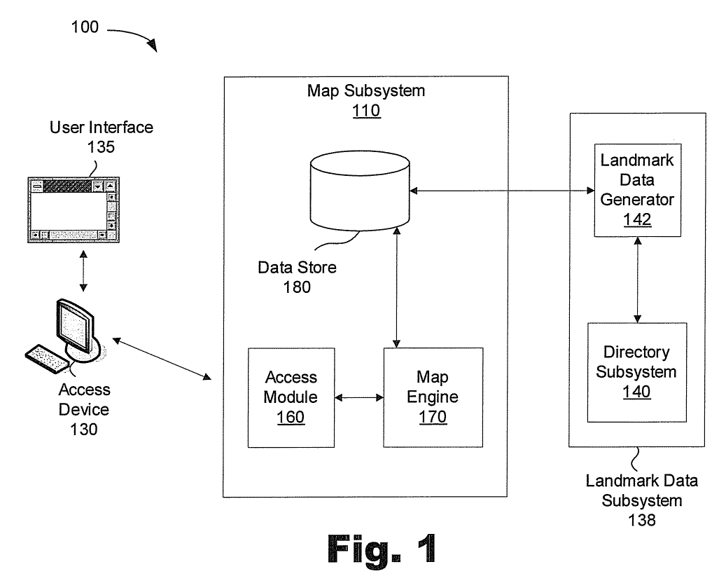

FIG. 1 illustrates an example of a map system 100 (or simply “system 100”). As shown in FIG. 1, system 100 may include a map subsystem 110 configured to communicate with an access device 130 that is configured to present a user interface 135 for consideration by a user of the access device 130. The system 100 further includes a landmark data subsystem 138 configured to communicate with the map subsystem 110 as shown in FIG. 1. The landmark data subsystem 138, which may include a directory subsystem 140 and a landmark data generator 142, may be configured to provide landmark data to the map subsystem 110. The map subsystem 110, which includes an access module 160, map engine 170, and data store 180, may be configured to generate and provide maps and landmark selection tools to the access device 130, as described below.

The elements of the system 100 may communicate using any known communication technologies, devices, media, and protocols supportive of data communications, including, but not limited to, the Internet, the World Wide Web, intranets, local area networks, wide area networks, mobile (e.g., cellular) telephone networks, wireless networks, optical fiber networks, satellite networks, telephone networks, packet-switched networks, other communications networks, data transmission media, communications devices, Transmission Control Protocol (“TCP”), Internet Protocol (“IP”), File Transfer Protocol (“FTP”), Telnet, Hypertext Transfer Protocol (“HTTP”), socket connections, Ethernet, data bus technologies, wireless communication technologies (e.g., WiFi), and other suitable communications technologies. In certain examples, the access device 130 and the map subsystem 110 communicate with one another via a communication network, which may include, but is not limited to, any of the networks listed above (e.g., the Internet).

In certain exemplary implementations, the elements of the system 100 are implemented in one or more computers. The system 100 may include any computer hardware and/or instructions (e.g., software programs), or combinations of software and hardware, configured to perform the processes described herein. In particular, it should be understood that the map subsystem 110 and the landmark data subsystem 138 may be implemented on one or more than one physical computing device. Accordingly, the system 100 may include any one of a number of well-known computing devices (e.g., one or more servers), and may employ any of a number of well-known computer operating systems, including, but by no means limited to, known versions and/or varieties of the Microsoft Windows® operating system, the Unix operating system, and the Linux operating system.

Accordingly, the processes described herein may be implemented at least in part as instructions executable by one or more computing devices, as is well known. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

While an exemplary system 100 is shown in FIG. 1, the exemplary components illustrated in the Figure are not intended to be limiting. Other alternative hardware environments and implementations may be used. Each of the components of the system 100 will now be described in additional detail.

### A. Access Device

The access device 130 may include any device physically or remotely accessible to one or more users (e.g., users requesting map data from the map subsystem 110) and that allows a user to provide input to and receive output from the map subsystem 110. For example, the access device 130 can include, but is not limited to, one or more desktop computers, laptop computers, tablet computers, personal computers, kiosks, personal data assistants, mobile (e.g., cellular) telephones, satellite pagers, wireless internet devices, embedded computers, video phones, network interface cards, mainframe computers, mini-computers, programmable logic devices, vehicles, personal communication devices, and any other devices capable of communicating with the driving directions subsystem 110. The access device 130 can also include various peripherals such as a terminal, keyboard, keypad, mouse, screen, printer, stylus, input device, output device, or any other apparatus that can help a user interact with the access device 130.

The access device 130 may be communicatively coupled to the map subsystem 110 using any suitable communication technologies, including any of the communication technologies listed above. In certain exemplary approaches, the access device 130 and the map subsystem 110 are configured to communicate via the Internet or World Wide Web.

The access device 130 provides access to the map subsystem 110. Accordingly, one or more users may utilize the access device 130 to provide requests to and receive output from the map subsystem 110. In particular, users are able to use the access device 130 to provide requests for map data to the map subsystem 110. The requests may include data representative of one or more geographic locations or areas, including a starting location and destination location. The locations may be identified by street addresses, city identifiers, state identifiers, territory identifiers, zip codes, airport codes, Global Positioning System coordinates, other suitable location identifiers, or any combination thereof.

Output from the map subsystem 110 may be provided to the access device 130 and may include data representative of maps representative of geographic areas. The output may also include at least one landmark selection tool enabling users to select landmarks to be displayed on the maps. Selected landmarks may be displayed as visual indicators on the maps. Examples of maps that may be generated and outputted by the map subsystem 110 are described further below. The access device 130 can present data representative of the maps, landmark selection tools, and related information in the user interface 135 for consideration by the user of the access device 130.

The access device 130 may include instructions for generating and operating the user interface 135. The instructions may be in any computer-readable format, including software, firmware, microcode, and the like. When executed by a processor (not shown) of the access device 130, the instructions may present the user interface 135 to a user of the access device 130, as is well known.

While FIG. 1 shows a single access device 130, this is only illustrative. One or more access devices 130 may communicate with and benefit from messages and/or data provided by the map subsystem 110.

### B. User Interface

The access device 130 may present the user interface 135 to a user as a way for the user to initiate communications with and/or consider output from the map subsystem 110. The user interface 135 may be equipped to present information to and receive input from users. As described below, for example, the user interface 135 may present data representative of maps and tools for controlling the contents of the maps to a user of the access device 130.

The user interface 135 may comprise one or more graphical user interfaces (“GUI”) capable of displaying information and receiving input from users. Several exemplary GUIs are described further below. In certain exemplary implementations, the user interface 135 includes a web browser, such as Internet Explorer® offered by Microsoft Corporation of Redmond, Wash.

However, the user interface 135 is not limited to a web form and may include many different types of user interfaces that enable users to utilize the access device 130 to communicate with the map subsystem 110. In some envisioned implementations, for example, the user interface 135 may include a voice interface capable of receiving input from and providing at least a subset of output to a user. Merely by way of example, the user interface 135 may include voice recognition applications.

### C. Landmark Data Subsystem

The landmark data subsystem 138 may include any device or combination of devices and communication technologies useful for communicating with the map subsystem 110, including any of the communication technologies described above. The landmark data subsystem 138 may also include any device or combination of devices and data storage and processing technologies useful for storing and processing data, including data useful for generating landmark data. Exemplary components of the landmark data subsystem 138 will now be described.

1. Directory Subsystem

The directory subsystem 140 may include any device or combination of devices and data storage and processing technologies useful for storing and managing directory data, including data commonly included in electronic yellow pages and/or white pages directories. As is well known, such data may include, but is not limited to, directory listings (e.g., business listings) and related information (e.g., business names, street addresses, contact information, and descriptions of products and/or services provided by the businesses). As described below, the data stored in the directory subsystem 140 may be used to generate landmark data to be stored in the data store 180 for inclusion in maps and landmark selection tools.

2. Landmark Data Generator

The landmark data generator 142 may be configured to extract data from one or more electronic data sources and use the extracted data to generate landmark data. For example, the landmark data generator 142 shown in FIG. 1 may include any suitable communication technologies for communicating with the directory subsystem 140, including technologies for extracting data from the directory subsystem 140. As mentioned above, the directory subsystem 140 may include directory data such as electronic data associated with yellow pages type directories. The landmark data generator 142 may be configured to query the directory subsystem 140 and extract data, or at least a subset of the data representative of directory listings. In certain implementations, the landmark data generator is configured to extract a listing identifier (e.g., a business name) and a street address (or other location identifier) corresponding with the listing identifier. Of course, additional data such as contact information associated with the directory listing may be extracted.

The extracted data may be stored as landmark data in the data store 180. In this manner, the landmark data generator 142 is able to populate the data store 180 with landmark data obtained from data stored in the directory subsystem 140. In certain examples, the landmark data generator 142 may be configured to obtain data from more than one source, including multiple directory subsystems and/or external parties (e.g., advertisers) providing information such as business listings. The landmark data generator 142 may also be configured to update the landmark data stored in the data store 180 to reflect updates to the data stored in the directory subsystem 140.

### D. Map Subsystem

The map subsystem 110 may include any device or combination of devices and communication technologies useful for communicating with the access device 130 and landmark data subsystem 138, including any of the communication technologies mentioned above. The map subsystem 110 may also include any device or combination of devices and data storage and processing technologies useful for storing and processing data, including data useful for generating representations of maps, landmark selection tools, and maps including landmark data. The components of the map subsystem 110 will now be described.

1. Data Store

The data store 180 may include one or more data storage mediums, devices, or configurations and may employ any type, form, and combination of well-known storage media, including hard disk drives, read-only memory, caches, databases, optical media, and random access memory. Data store 180 may include any technologies useful for storing, updating, modifying, accessing, retrieving, deleting, and managing data.

The data store 180 may store any data useful for the generation of maps, including maps having landmark data. For example, the data store 180 may include Geocode data, map data, location identifiers (e.g., street addresses, Global Positioning System (“GPS”) coordinates, etc.), listings (e.g., directory listings), graphics (e.g., raster and/or vector graphics), and any other data and/or graphics useful for generating maps, as is well known. In addition, the data store 180 may include landmark data representative of landmarks. The landmark data may be obtained from the landmark data subsystem 138 as described above. The landmark data in data store 180 may be used to generate landmark selection tools and maps, including maps having landmark data displayed thereon.

The data stored in the data store 180 may be provided and/or maintained manually, automatically, or with a combination of manual and automatic steps. In certain approaches, for example, landmark data may be manually defined and stored in the data store 180. In other approaches, the landmark data generator 142 may automatically store and update landmark data in the data store 180.

2. Map Engine

The map engine 170 may be configured to receive and fulfill requests for maps. The map engine 170 typically receives such requests from the access module 160, which has received the requests from the access device 130, as described below. When a request for a map is received, the map engine 170 may query the data store 180 for data useful for generating one or more maps to fulfill the request. In certain implementations, the map engine 170 is configured to use data stored in the data store 180 to generate conventional street maps (e.g., driving direction street maps), as is well known.

In addition, the map engine 170 may be configured to use landmark data stored in the data store 180 to generate and provide at least one landmark selection tool. In certain envisioned approaches, for example, the map engine 170 is able to query the data store 180 for landmark data associated with landmarks that are located within the geographic area represented by a map. To illustrate, in response to a request, the map engine 170 may generate a street map representative of a geographic area, as is well known. The map engine 170 may also search the landmark data in the data store 180 to identify data representative of landmarks located within the geographic area. In some examples, the map engine 170 is able to search the landmark data for location identifiers (e.g., street addresses) located within certain areas (e.g., along certain street segments) in the geographic area. Accordingly, street names and street numbers (or other location identifiers) included in the landmark data can be used to identify landmarks that are located within geographic areas represented by maps. Of course, other suitable methods of identifying landmarks included in the geographic area may be employed.

The identified landmark data can then be used to create a landmark selection tool including at least one selectable landmark option that is associated with at least one landmark located in the geographic area. As described below, the map subsystem 110 can provide one or more landmark selection tools to the access device 160 for consideration and utilization by a user of the access device 160. Exemplary landmark selection tools are described further below.

A user may utilize a landmark selection tool to select at least one landmark to be displayed on a map. For example, the user may select a selectable landmark option associated with a landmark to be displayed on the map. Data representative of a user selection may be received by the access module 160 and forwarded to the map engine 170, which may be configured to combine selected landmark data with the map. Select landmark data may be combined with the map in any suitable manner. In certain exemplary implementations, for example, the map engine 170 may be configured to generate an overlay including at least one visual indicator representative of at least one landmark. The overlay may be displayed with the map such that the visual indicator is displayed on the map. In other envisioned implementations, at least one visual indicator may be integrated with the map and the updated map provided to the access device 130. The map engine 170 may be configured to use any suitable map data and map projection and/or rending heuristics to correlate at least approximate geographic locations of selected landmarks with appropriate positions on the map (e.g., pixels or groups of pixels in the map).

In this or similar manner, a conventional map may be augmented with one or more visual indicators representative of selected landmarks and at least the approximate locations of the selected landmarks in the geographic area represented by the map. The visual indicators may be generated based on and/or may include landmark data obtained from the data store 180, which data may include, but is not limited to, a landmark identifiers, location identifiers (e.g., addresses), contact information (e.g., a telephone number, e-mail address, or website address), and one or more hyperlinks to additional information associated with landmarks or the sponsors of the landmarks. For example, a visual indicator may include a hyperlink to a directory listing associated with a landmark.

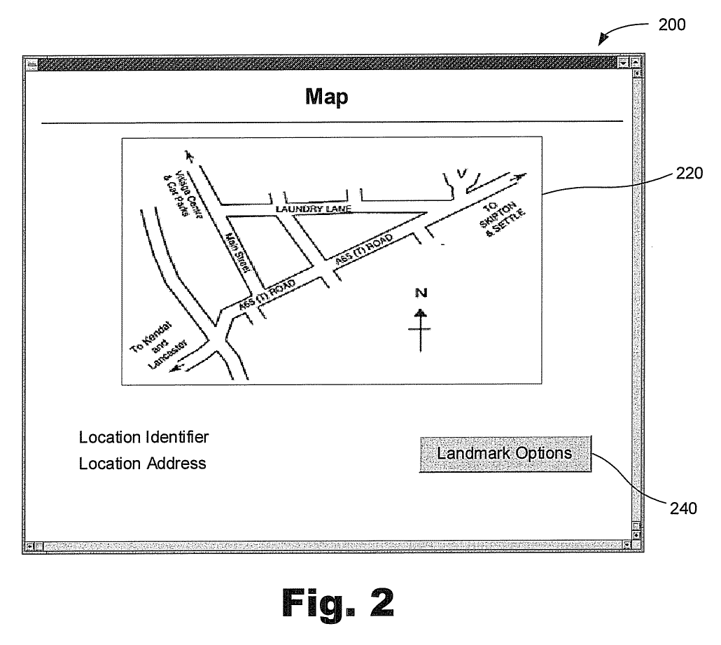

The map engine 170 may provide data representative of visual indicators (e.g., in a map overlay) to the access module 160 for transmission to the access device 130, which can display the visual indicators at appropriate positions on the map in the user interface 135 for consideration by the user. The output from the map engine 170 may be in any suitable data format(s) and may include any acceptable representation of maps, landmark selection tools, visual indicators, and/or landmark data. Exemplary maps, landmark selection tools, and visual indicators will be described below in relation to FIGS. 2-7.

3. Access Module

The access module 160 may include any suitable communication technologies for communicating with the map engine 170 and the access device 130. In certain exemplary approaches, the access module 160 includes or is implemented in one or more servers (e.g., web servers) configured to communicate with the access device 130. The communications between the access module 160 and the access device 130 may be transmitted over any suitable communication network, including the Internet or the World Wide Web.

The access module 160 may be configured to receive from the access device 130 data representative of requests for maps, as described above. The requests may be forwarded from the access module 160 to the map engine 170, which generates responses to the requests, as described above.

The access module 160 is configured to receive output (e.g., the responses to the requests) from the map engine 170. The access module 160 may process the output, including ensuring that it is in suitable form for transmission to the access device 130. For example, the access module 160 may be configured to insert the output, including data representative of maps and landmark data, into Hypertext Markup Language (“HTML”) messages for transmission to the access device 130 using Hypertext Transport Protocol (“HTTP”). Of course, other suitable data formats and protocols may be used.

As described above, the access device 130 is able to receive output (e.g., map data) from the access module 160 and present data representative of the output in the user interface 135 for consideration by a user. FIG. 2 illustrates an exemplary graphical user interface (“GUI”) 200 that may be presented in the user interface 135. As shown in FIG. 2, GUI 200 may include data representative of a map 220. Map 220 may include a street map representative of a geographic area.

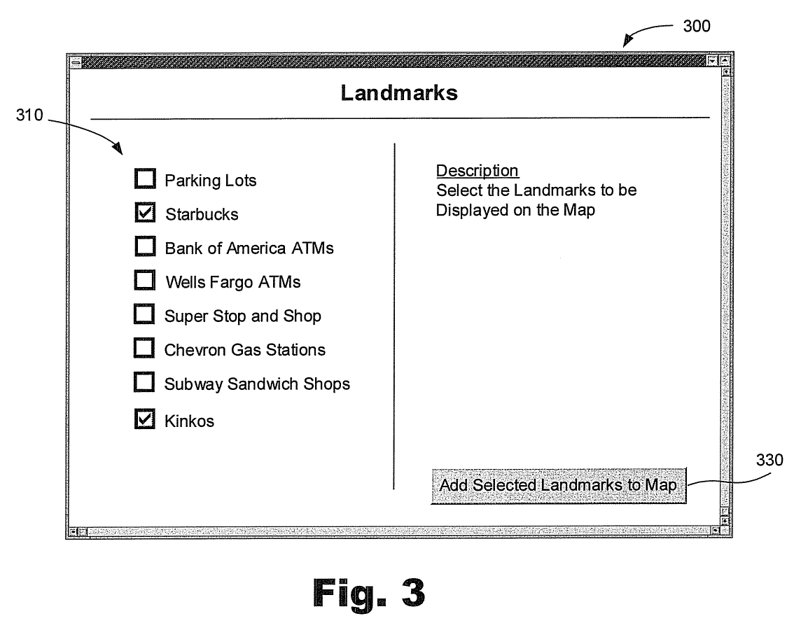

GUI 200 may also include a landmark options link 240 that is selectable by a user of the access device 130. When the user selects the landmark options link 240, at least one landmark selection tool may be provided for utilization by the user. For example, FIG. 3 illustrates an exemplary graphical user interface (“GUI”) 300 that may be provided to the user when the landmark options link 240 of FIG. 2 is selected. As shown in FIG. 3, GUI 300 may include a landmark selection tool 310 having a plurality of selectable landmark options. The selectable landmark options may be presented as a menu from which the user is able to select associated landmarks to be displayed on the map 220. In the example shown in FIG. 3, each of the landmark options includes a selectable check box and information identifying the associated landmark(s). The user may select a check box of an associated landmark to be included in the map 220. The user may also deselect a check box of an associated landmark to be removed from the map 220. Any or all of the check boxes may be initially selected or unselected in accordance with a predefined default setting. GUI 300 may include an “Add Selected Landmarks to Map” tool 330 that may be selected by the user to instruct the map subsystem 110 to display the landmarks associated with the selected landmark options to the map 220, as described below.

In certain exemplary implementations, each of the selectable landmark options is associated with one landmark. That is, each specific pre-selected landmark located within the geographic area represented by map 220 may be associated with an individual selectable landmark option in the landmark selection tool 310. In other exemplary implementations, each of the selectable landmark options may be associated with one or more landmarks that have been grouped by a common attribute. For example, a “Parking Lots” selectable landmark tool may be associated with one or more parking lot locations located within the geographic area, and a “Starbucks” selectable landmark tool may be associated with one or more locations of Starbucks coffee shops that are located within the geographic area.

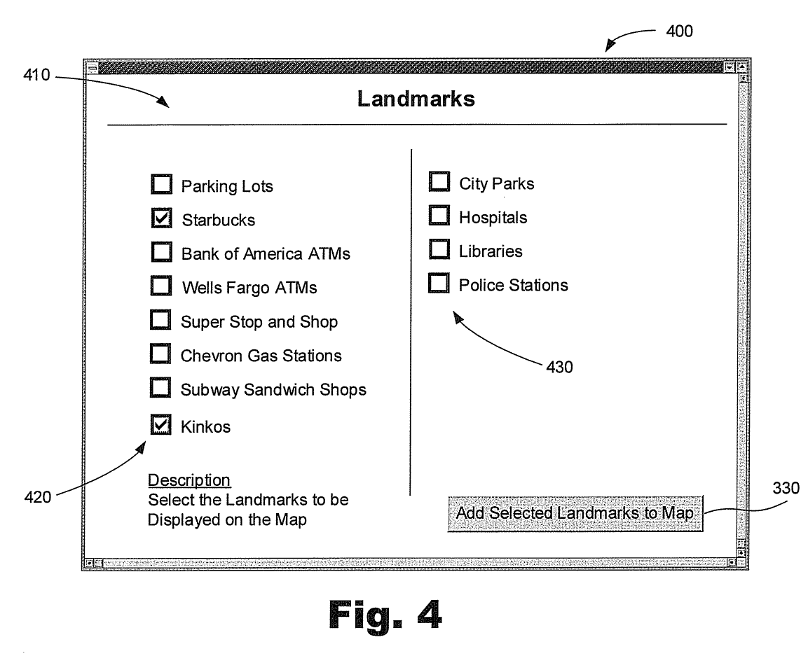

The exemplary landmark selection tool 310 shown in FIG. 3 includes a plurality of selectable landmark options organized into a single menu. This is not limiting, however. Other landmark selection tools 310 may include selectable landmark options organized in different ways. For example, FIG. 4 illustrates a graphical user interface 400 including another landmark selection tool 410, which includes two separate sets of selectable landmark options. A first subset 420 of the selectable landmark options may be associated with landmarks that are sponsored by third parties (e.g., advertisers) who have agreed to pay fees associated with the inclusion of their landmarks in the landmark selection tool 410 and/or map 220. A second subset 430 of the selectable landmark options may include non-sponsored landmarks that may be referred to as points of interest. Points of interest may include landmarks that for whatever reason may be of general public interest and/or not commonly sponsored. As shown in FIG. 4, examples of points of interest include, but are not limited to, city parks, hospitals, libraries, and police stations. The configuration shown in GUI 500 may be useful for ensuring that frequently requested landmarks, even if not sponsored, are available for selection and display on maps. The separation can also benefit sponsors by preventing direct competition (e.g., prioritization within a list) between sponsored and un-sponsored landmarks.

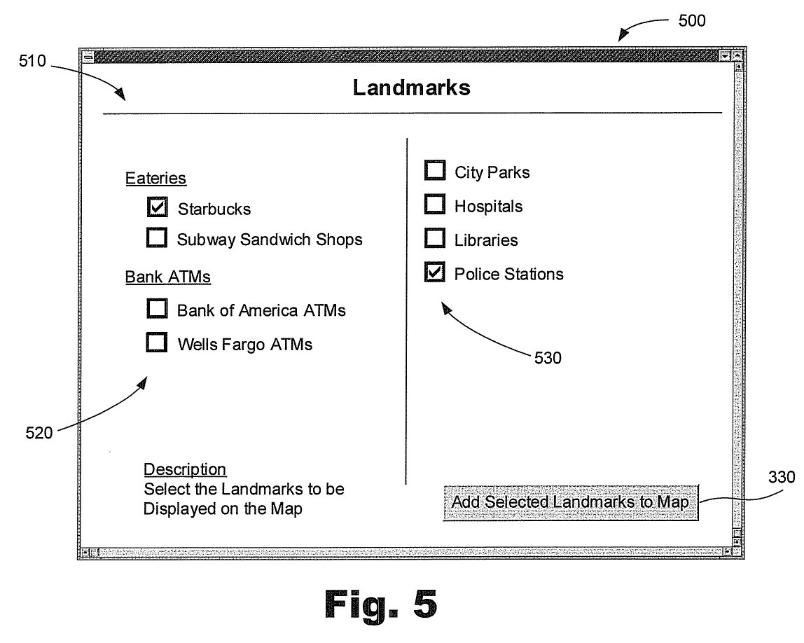

FIG. 5 illustrates a graphical user interface (“GUI”) 500 including another exemplary landmark selection tool 510 with landmark selection tools organized into a first subset 520 and a second subset 530 as described above. In addition, the first subset 520 of selectable landmark options has been organized into categories. Any suitable categories that may be helpful to a user can be employed. For example, categories commonly used in yellow pages directories may be used. The categories may be identified based on the landmark data stored in data store 180, especially where the landmark data has been generated based on directory listings in a directory subsystem. Although not limiting in any sense, GUI 500 shows exemplary categories including “Eateries” and “Bank ATMs.” The “Eateries” category may include any location providing food or drink, such as “Starbucks” coffee houses and “Subway” sandwich shops. The “Bank ATMs” category may include any location of an ATM such as a “Bank of America” ATM and a Wells Fargo ATM, for example.

Selectable landmark options may be prioritized (e.g., ordered within a list) in relation to one another. The prioritization may be based on any suitable predefined criteria. In certain implementations, for example, selectable landmark options may be presented in alphabetic order. In other examples, selectable landmark options may be ordered in accordance with sponsorship fees. For instance, sponsors may pay relatively higher fees to have the selectable landmark options associated with their landmarks displayed more prominently (e.g., at or near the top of a list) than other selectable landmark options. This can promote competition among sponsors, which may help increase revenue generated by the system 100.

Competition between sponsors can be isolated to specific groups so that sponsors providing similar products and/or services compete with one another and not with sponsors of unrelated products and services. For example, sponsors having landmarks within an “Eateries” category may bid for prioritization of landmark selection options within the category. In FIG. 5, for instance, the “Starbucks” landmark option may be listed above the “Subway” landmark option when a “Starbucks” sponsor has agreed to a higher fee than that agreed to by a “Subway” sponsor. The order of selectable landmarks within other categories may be selected independently of the “Eateries” category. This feature is especially helpful when different categories of products and services draw widely disparate fee amounts. An exemplary revenue subsystem will be described further below.

Along with selectable landmark options, GUI 300, 400, or 500 may also include the selectable “Add Selected Landmarks to Map” tool 330 (also referred to as the “add landmarks tool 330”) mentioned above. The user may select the add landmarks tool 330 to instruct the map subsystem 110 to add landmark data corresponding with any selected landmark option to map 220. The map subsystem 110 may detect the selection and function as described above to include data representative of the selected landmarks (e.g., visual indicators) on map 220. In certain implementations, selected landmark data is provided (e.g., downloaded) to the access device 130 to be appended (e.g., added as an overlay) to map 220. In other implementations, the map subsystem 110 may generate and provide an updated map 220 including the selected landmark data. In other implementations, the landmark data associated with a landmark selection tool may have been previously provided to the access device 130 along with the map 220, and the access device 130 may be configured to detect the user selection of at least one landmark selection option and locally update a display of the map 220 to include the selected landmark data.

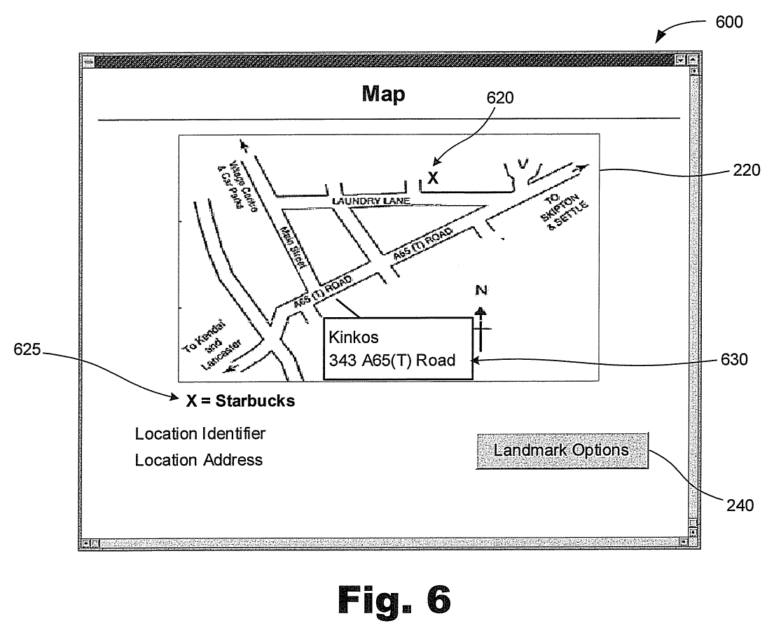

FIG. 6 illustrates a graphical user interface (“GUI”) 600 that may be presented to the user in response to the user selecting landmark options associated with the “Starbucks” and “Kinkos” landmarks included in the landmark selection tool 310, 410, or 510 and then selecting the add landmarks tool 330. As shown in FIG. 6, GUI 600 may include the map 220 of FIG. 2 with visual indicators of landmark data displayed thereon. A visual indicator 620 for a “Starbucks” landmark is displayed as an “X” on map 220. GUI 600 may also include a legend 625 illustrating the association between the visual indicator 620 and a “Starbucks” landmark. The visual indicator 620 may be positioned at an appropriate position on the map 220, the position indicating at least the approximate location of the “Starbucks” landmark in the geographic area represented by the map 220.

Of course, any suitable identifiers (e.g., visual indicators) may be used to represent landmarks in relation to the map 220. Another exemplary visual indicator 630 is included in map 220 and represents a “Kinkos” landmark, Visual indicator 630 includes a callout having information about the landmark (e.g., a landmark name and street address) and a line pointing to an appropriate position on the map 220 that is representative of the approximate location of the landmark in the geographic area represented by the map 220. In other implementations, visual indicator 630 may include at least one hyperlink to additional information associated with the landmark, including a hyperlink to a directory listing associated with the landmark. At any time, the user may select the landmark options link 240 in GUI 600 to access a landmark selection tool and update the landmark data displayed on the map 220.

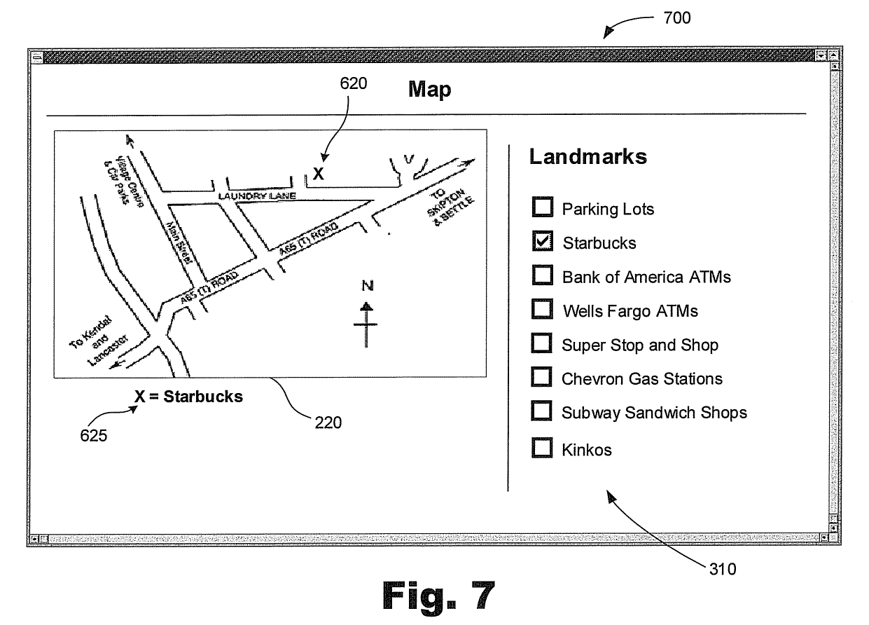

While FIGS. 2-6 illustrate exemplary GUIs displaying examples of maps and/or landmark selection tools, the examples are not limiting in any sense. Other GUIs may also include maps and/or landmark selection tools configured as may serve a particular application or implementation of system 100. For example, FIG. 7 illustrates another graphical user interface (“GUI”i) 700 including both map 220 and landmark selection tool 310. GUI 700 can be used to enable quick selection and display of landmark data, without having to individually load different map and landmark selection GUIs. Thus, when a user selects a “Starbucks” landmark option in GUI 700, map 220 may be updated in real time to include a visual indicator for any “Starbucks” landmark located in the geographic area represented by map 220. GUI 700 may be especially useful in implementations in which landmark data is downloaded to the access device 130 along with map data so that the access device 130 can detect user selections and locally update the map 220, without having to call back to the map subsystem 110 for additional landmark data.

### E. Revenue Subsystem

Sponsors (e.g., advertisers) may wish to have landmark data for specific landmarks included in landmark selection tools and maps, including any of the landmark selection tools and maps described above. Accordingly, the system 100 may be configured to generate revenue by charging sponsors for the inclusion, selection, prioritization, and/or display of landmark data in landmark selection tools and/or maps. Accordingly, inclusion and/or prioritization of landmark data in landmark selection tools and/or maps may be based on fees agreed to be paid by sponsors associated with landmarks.

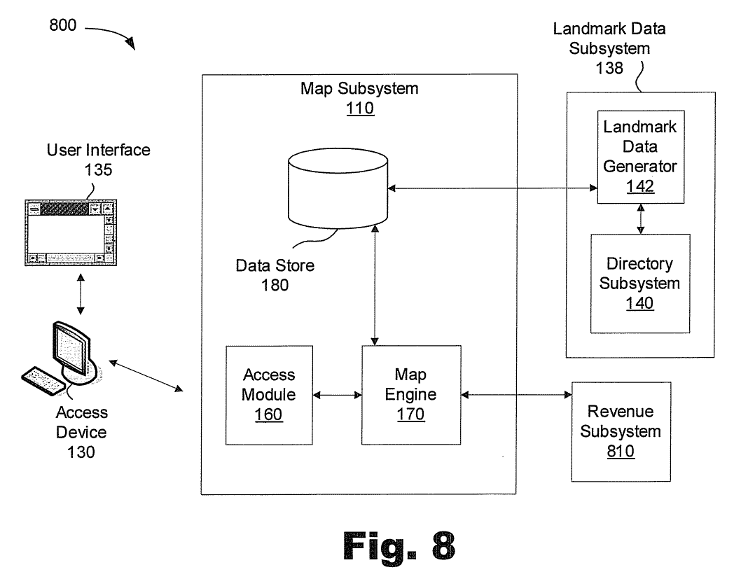

FIG. 8 is a block diagram illustrating another exemplary map system 800 (or simply “system 800”). As shown in FIG. 8, the system 800 includes the elements of the system 100 of FIG. 1. In addition, the system 800 of FIG. 8 includes a revenue subsystem 810 configured to communicate with the map subsystem 110. The revenue subsystem 810 and the map subsystem 110 may use any of the communication technologies described above to communicate.

The revenue subsystem 810 may be configured to track fees to be charged to sponsors in connection with the inclusion of sponsored landmark data in landmark selection tools and/or maps. In certain implementations, for example, the revenue subsystem 810 is configured to charge a sponsor for each inclusion of landmark data associated with the sponsor in landmark selection tools. In other implementations, the revenue subsystem 810 may be configured to charge a sponsor for each inclusion of selected landmark data in a map (e.g., for each display of a visual indicator associated with a landmark). Such billing arrangements may be referred to as “pay-per-inclusion” or “pay-per-appearance” fee schedules, respectively.

Any suitable fee arrangement may be used to charge sponsors. For example, sponsors may be asked to pay a flat fee to secure the right to have landmark data included in landmark selection tools and/or maps during a predefined time interval. By way of another example, sponsors may be asked to bid for the right to have their landmark data included in landmark selection tools and/or maps. For instance, sponsors submitting higher bids may qualify their landmark data for inclusion while landmark data associated with sponsors submitting lower bids is omitted.

Sponsors may also be charged for prioritization of landmark data within landmark selection tools. For example, sponsors may be asked to bid to establish priorities between selectable landmark options included in a landmark selection tool. A landmark associated with a sponsor having submitted the highest bid may be assigned priority over other landmarks. As mentioned above, the priority of landmarks can be used to determine an order in which landmark data will be presented in a list of selectable landmark options such as those included in landmark selection tool 310, 410, or 510. Thus, in certain implementations sponsors are able to bid to increase the exposure and/or prominence of their landmark data. For example, two gas stations located on different corners of an intersection may bid against each other for priority positioning of their landmark data in a landmark selection tool.

The revenue subsystem 810 may receive, from the map engine 170, data representative of the instances of landmark data being included in landmark selection tools and/or maps. Based on this data, the revenue subsystem 810 can charge sponsors. The landmark data may include identifiers associated with and useful by the revenue subsystem 810 for identifying sponsors to be charged for the inclusions of landmark data.

The revenue subsystem 810 may communicate information to the map engine 170, which may use the information to determine the landmark data (e.g., selectable landmark options) to be included in landmark selection tools and/or the prioritization of the landmark data within the landmark selection tools. Accordingly, system 800 can be used to generate revenue (e.g., advertising revenue) in exchange for the inclusion and/or prioritization of landmark data in landmark selection tools and maps.

### III. Exemplary Process View

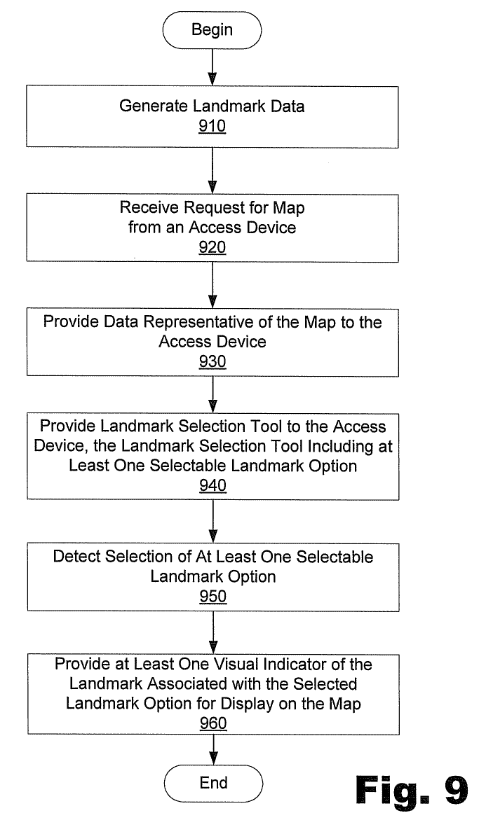

FIG. 9 is a flowchart illustrating an exemplary process for providing a landmark selection tool for selection of landmarks for display on a map. While FIG. 9 illustrates exemplary steps according to one implementation, other implementations may omit, add to, reorder, and/or modify any of the steps shown in FIG. 9.

In step 910, landmark data is generated. Step 910 may be performed in any of the ways described above, including using directory listings from one or more directory databases to manually or automatically define the landmark data. The landmark data may be stored in data store 180 for use in generating maps, landmark selection tools, and maps including visual indicators of select landmarks.

In step 920, a request for a map is received from an access device such as the access device 130. Step 620 may be performed in any of the ways described above, including the map subsystem 110 receiving the request, which may include any data potentially helpful for identifying and/or rendering a map view of a geographic area.

In step 930, data representative of the requested map is provided to the access device 130. The map may be generated based on and in response to the request received in step 920. Step 930 may be performed in any of the ways described above. For example, the map engine 170 may use data in the data store 180 to generate a conventional digital street map that can be transmitted to the access device 130 for presentation to a user.

In step 940, at least one landmark selection tool is provided to the access device 130. The landmark selection tool includes at least one selectable landmark option associated with at least one landmark including in the geographic area represented by the map. Step 940 may be performed in any of the ways described above. For example, the map engine 170 may use landmark data in the data store 180 to generate the at least one selectable landmark option to be included in the landmark selection tool. In certain implementations, the map engine 170 identifies landmark data associated with landmarks located within the geographic area represented by the map. This landmark data may be included in the landmark selection tool, which can be transmitted to the access device 130 in any suitable manner.

In step 950, a selection of the at least one selectable landmark option is detected. Step 950 may be performed in any of the ways described above, including a user of the access device 130 selecting the at least one selectable landmark option from a plurality of selectable landmark options included in the landmark selection tool.

In step 960, at least one visual indicator of at least one landmark associated with the selected landmark option is provided for display on the map. Step 960 may be performed in any of the ways described above, including generating and providing a map overlay including the at least one visual indicator to the access device 130 or otherwise displaying the visual indicator at an appropriate position on the map.

Variations of the exemplary process illustrated in FIG. 9 may include one or more billing steps associated with charging sponsors fees for the inclusion and/or prioritization of landmark data in the landmark selection tool and/or map, as described above. Further, step 940 may include selecting and/or prioritizing the at least one selectable landmark option based on sponsor fees.

The above-described systems and methods provide user-friendly, customizable maps. Landmark selection tools are also provided. These tools enable users to control the information that is included in the maps. Users can customize landmark data included in maps to fit specific user preferences and situations. These and other features of the present systems and methods can help improve the ability of users to create maps that are customized for particular situations and individual preferences.

While certain examples described herein relate to the display of maps, landmark selection tools, and landmark data in graphical user interfaces that may be presented in a user interface 135 by an access device 130, other implementations may be directed to other forms of presentation. For example, the above-described landmark selection tools may be used to control the landmark data to be included in printouts of maps. For example, a landmark selection tool may be provided to a user in conjunction with print options related to a hardcopy printing of a map.

### IV. Alternative Embodiments

The preceding description has been presented only to illustrate and describe exemplary approaches to the invention. It is not intended to be exhaustive or to limit the invention to any precise form disclosed. The invention may be practiced otherwise than is specifically explained and illustrated without departing from its spirit or scope. For example, the exemplary systems and methods described above may be implemented in a driving directions application. It is intended that the scope of the invention be defined by the following claims.

What is claimed is:

1. A system comprising:
a map subsystem configured to
provide data representative of a map to an access device communicatively coupled to said map subsystem, the map being representative of a geographic area,
provide a landmark selection tool to the access device, the landmark selection tool including at least one selectable landmark option associated with at least one landmark located within the geographic area,
detect a user selection of the at least one selectable landmark option, and
provide, in response to the user selection, at least one visual indicator of the at least one landmark for display on the map.

2. The system of claim 1, wherein the at least one selectable landmark option includes a plurality of selectable landmark options configured to be displayed in a graphical user interface for consideration by a user of the access device.

3. The system of claim 2, wherein at least a subset of the selectable landmark options are sponsored by at least one sponsor.

4. The system of claim 2, wherein said map subsystem is configured to prioritize the selectable landmark options in relation to one another for display in the graphical user interface based on sponsor fees associated with the selectable landmark options.

5. The system of claim 2, wherein said map subsystem is configured to
organize the selectable landmark options into a plurality of categories for display in the graphical user interface, one of the categories including a subset of the selectable landmark options; and
prioritize the selectable landmark options in the category in relation to one another for display in the graphical user interface based on sponsor fees associated with the selectable landmark options included in the category.

6. The system of claim 1, wherein the at least one visual indicator indicates at least one approximate location of the at least one landmark within the geographic area.

7. The system of claim 1, wherein the at least one visual indicator includes at least one hyperlink to at least one directory listing associated with the at least one landmark.

8. The system of claim 1, further comprising a landmark data subsystem providing landmark data to the map subsystem, said map subsystem being configured to
identify at least a subset of the landmark data that is representative of the at least one landmark located in the geographic area; and
generate the at least one selectable landmark option based on the identified landmark data.

9. The system of claim 8, wherein said map subsystem is configured to generate the at least one visual identifier based on the identified landmark data.

10. The system of claim 8, wherein said landmark data subsystem includes:
a directory subsystem including a plurality of directory listings; and
a landmark data generator configured to generate the landmark data based on the plurality of directory listings.

11. The system of claim 1, further comprising a revenue subsystem communicatively coupled to said map subsystem and configured to charge at least one sponsor a fee for at least one of the inclusion of the at least selectable landmark option in the landmark selection tool, a prioritization of the at least one selectable landmark option in the landmark selection tool, the user selection of the at least one selectable landmark option, and the display of the at least one visual indicator on the map.

12. A system comprising:
a landmark data subsystem providing landmark data; and
a map subsystem communicatively coupled to said landmark data subsystem and an access device, said map subsystem being configured to
provide data representative of a map to the access device, the map being representative of a geographic area,
use at least a subset of the landmark data to generate a plurality of selectable landmark options associated with a plurality of landmarks located in the geographic area,
prioritize at least a subset of the selectable landmark options in relation to one another based on sponsor fees associated with the landmarks,
provide the plurality of selectable landmark options, including the prioritized at least a subset of the selectable landmark options, to the access device for display in a graphical user interface,
detect a user selection of one of the selectable landmark options, and
provide, in response to the user selection, a visual indicator of the landmark associated with the selected selectable landmark option for display on the map.

13. The system of claim 12, wherein said landmark data subsystem includes:
a directory subsystem including a plurality of directory listings; and
a landmark data generator configured to generate the landmark data based on the plurality of directory listings.

14. The system of claim 13, wherein the visual indicator includes a hyperlink to one of the directory listings associated with the landmark.

15. A method comprising:
providing data representative of a map to an access device, the map being representative of a geographic area;
providing a landmark selection tool to the access device, the landmark selection tool including at least one selectable landmark option associated with at least one landmark located within the geographic area;
detecting a user selection of the at least one selectable landmark option; and
providing, in response to the user selection, at least one visual indicator of the at least one landmark for display on the map.

16. The method of claim 15, further comprising displaying the map and the at least one visual indicator on the map in a graphical user interface for consideration by a user of the access device.

17. The method of claim 16, said displaying of the at least one visual indicator indicating at least one approximate location of the at least one landmark in the geographic area.

18. The method of claim 15, further comprising:
generating landmark data from at least one listing stored in a directory subsystem;
using the landmark data to identify the at least one landmark as being located in the geographic area; and
using the landmark data to generate the at least one selectable landmark option.

19. The method of claim 15, further comprising the step of configuring said map subsystem and generating the at least one visual identifier based on the landmark data.

20. The method of claim 15, further comprising charging at least one sponsor associated with the at least one landmark for at least one of (i) including the at least one selectable landmark option in the landmark selection tool, (ii) prioritizing the at least one selectable landmark option in the landmark selection tool, (iii) the user selecting of the at least one selectable landmark option, and (iv) the displaying of the at least one visual indicator on the map.
